(19) United States
(12) Patent Application Publication
(10) Pub. No.: US 2023/0261251 A1
(43) Pub. Date: Aug. 17, 2023

(54) NEGATIVE ELECTRODE AND ZINC SECONDARY BATTERY

(71) Applicant: NGK INSULATORS, LTD., Nagoya-City (JP)

(72) Inventors: Hiroshi MATSUBAYASHI, Suzuka- City (JP); Sota SHIMIZU, Nagoya-City (JP); Eiichi HIRAYAMA, Nagoya-City (JP); Sana IWAI, Kakamigahara-City (JP)

(73) Assignee: NGK INSULATORS, LTD., Nagoya-City (JP)

(21) Appl. No.: 18/194,684

(22) Filed: Apr. 3, 2023

Related U.S. Application Data
(63) Continuation of application No. PCT/JP2021/041469, filed on Nov. 11, 2021.

(30) Foreign Application Priority Data
Dec. 3, 2020 (JP) 2020-201339
Mar. 12, 2021 (JP) 2021-040840

(51) Int. Cl. H01M 10/054; H01M 4/52; H01M 4/48; H01M 4/38; H01M 4/36; H01M 4/62; H01M 50/489; H01M 50/46; H01M 50/431; H01M 12/08

(52) U.S. Cl. CPC H01M 10/054; H01M 4/523; H01M 4/483; H01M 4/38; H01M 4/364; H01M 4/622; H01M 50/489; H01M 50/46; H01M 50/431; H01M 12/08; H01M 2004/027

(57) ABSTRACT

Provided is a negative electrode for use in a zinc secondary battery, including a negative electrode active material containing ZnO particles and Zn particles, and a nonionic water-absorbing polymer, and at least a portion of the ZnO particles is covered with the nonionic water-absorbing polymer.

### CROSS-REFERENCE TO RELATED APPLICATIONS

This application is a continuation application of PCT/JP2021/041469 filed Nov. 11, 2021, which claims priority to Japanese Patent Application No. 2020-201339 filed Dec. 3, 2020 and Japanese Patent Application No. 2021-040840 filed Mar. 12, 2021, the entire contents all of which are incorporated herein by reference.

### BACKGROUND OF THE INVENTION

### 1. Field of the Invention

The present invention relates to a negative electrode and a zinc secondary battery.

### 2. Description of the Related Art

In zinc secondary batteries such as nickel-zinc secondary batteries, air-zinc secondary batteries, etc., metallic zinc precipitates from a negative electrode in the form of dendrites upon charging, and penetrates into voids of a separator such as a nonwoven fabric and reaches a positive electrode, which is known to result in bringing about short-circuiting. The short circuit due to such zinc dendrites shortens the life in repeated charge/discharge cycles.

In order to deal with the above issues, batteries comprising layered double hydroxide (LDH) separators that prevent penetration of zinc dendrites while selectively permeating hydroxide ions, have been proposed. For example, Patent Literature 1 (WO2013/118561) discloses that an LDH separator is provided between a positive electrode and a negative electrode in a nickel-zinc secondary battery. Moreover, Patent Literature 2 (WO2016/076047) discloses a separator structure comprising an LDH separator fitted or joined to a resin outer frame, and discloses that the LDH separator has a high density to the degree that it has gas impermeability and/or water impermeability. Moreover, this literature also discloses that the LDH separator can be composited with porous substrates. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to a porous substrate and subjecting the porous substrate to hydrothermal treatment in an aqueous solution of raw materials to form the LDH dense membrane on the surface of the porous substrate.

By the way, another factor that shortens the life of a zinc secondary battery includes a morphological change of zinc which is a negative electrode active material. More specifically, as zinc repeatedly dissolves and precipitates due to repeated charge and discharge, the negative electrode changes its morphology, causing high resistance due to clogging of pores, a decrease in a charge active material due to accumulation of isolated zinc, and the like, which results in difficulty in charge and discharge. In order to address this problem, Patent Literature 4 (WO2020/049902) proposes using as a negative electrode, a combination of ZnO particles and at least two selected from the group consisting of (i) metal Zn particles with a predetermined particle size, (ii) a predetermined metal element, and (iii) a binder resin having a hydroxyl group. According to this negative electrode, it is inhibited from being deteriorated due to repeated charge/discharge cycles to improve its durability in a zinc secondary battery, thereby enabling prolongation of a cycle life.

Moreover, Patent Literature 5 (JP6190101B) discloses a negative electrode mixture containing a negative electrode active material such as metallic Zn and ZnO, a polymer such as an aromatic group-containing polymer, an ether group-containing polymer, or a hydroxyl group-containing polymer, and a conductive aid that is a compound of elements such as B, Ba, Bi, Br, Ca, Cd, Ce, Cl, F, Ga, Hg, In, La, and Mn, which is suitable for forming storage batteries that exhibit battery performance such as high cycle characteristics, rate characteristics, and coulomb efficiency, while inhibiting morphological changes of an electrode active material, such as shape change and dendrites of the electrode active material, as well as dissolution, corrosion, and formation of passive state, of the electrode active material.

### CITATION LIST

### Patent Literature

Patent Literature 1: WO2013/118561
Patent Literature 2: WO2016/076047
Patent Literature 3: WO2016/067884
Patent Literature 4: WO2020/049902
Patent Literature 5: JP6190101B

### SUMMARY OF THE INVENTION

However, the charge/discharge cycle performance of conventional zinc secondary batteries is not always sufficient, thereby requiring its further improvement.

The present inventors have recently found that a cycle life can be prolonged by using as a negative electrode, a mixture containing a nonionic water-absorbing polymer together with Zn particles and ZnO particles, wherein at least a portion of the ZnO particles is covered with the nonionic water-absorbing polymer in the negative electrode.

Therefore, an object of the present invention is to provide a negative electrode capable of prolonging the cycle life of a zinc secondary battery.

According to an aspect of the present invention, there is provided a negative electrode for use in a zinc secondary battery, comprising:
a negative electrode active material comprising ZnO particles and Zn particles, and
a nonionic water-absorbing polymer,
wherein at least a portion of the ZnO particles is covered with the nonionic water-absorbing polymer.

According to an aspect of the present invention, there is provided a zinc secondary battery, comprising:
a positive electrode,
the negative electrode,
a separator separating the positive electrode from the negative electrode so as to be capable of conducting hydroxide ions therethrough, and
an electrolytic solution.

### BRIEF DESCRIPTION OF THE DRAWINGS

FIG. 1 is a schematic cross-sectional view of a ZnO particle partially covered with a nonionic water-absorbing polymer in the negative electrode of the present invention.

FIG. 2A is a conceptual view explaining a presumed mechanism of the phenomenon that occurs upon charging reaction of the negative electrode according to the present invention and a view illustrating a state in an early stage of charge.

FIG. 2B is a conceptual view explaining a presumed mechanism of the phenomenon that occurs upon charging reaction of the negative electrode according to the present invention and a view illustrating a state in a middle stage of charge, following FIG. 2A.

FIG. 2C is a conceptual view explaining a presumed mechanism of the phenomenon that occurs upon charging reaction of the negative electrode according to the present invention and a view illustrating a state in a late stage of charge, following FIG. 2B.

FIG. 3A is a conceptual view explaining a presumed mechanism of the phenomenon that occurs upon discharging reaction of the negative electrode according to the present invention and a view illustrating a state upon beginning of discharge.

FIG. 3B is a conceptual view explaining a presumed mechanism of the phenomenon that occurs upon discharging reaction of the negative electrode according to the present invention and a view illustrating a state upon progress of discharge, following FIG. 3A.

FIG. 4 is a graph illustrating an example of the relationship between the amount of water absorbed and the amount of KOH collected per 1 cm³ of a nonionic water-absorbing polymer, and the KOH concentration.

FIG. 5 is a cross-sectional image of the negative electrode, observed by FE-SEM in Example 5.

FIG. 6 is an EDX elemental mapping image in the cross-section of the negative electrode shown in FIG. 5.

FIG. 7 is a cross-sectional image of the negative electrode, observed by FE-SEM in Example 1 (Comparative Example).

FIG. 8 is a cross-sectional image of the negative electrode, observed by FE-SEM in Example 6.

### DETAILED DESCRIPTION OF THE INVENTION

### Negative Electrode

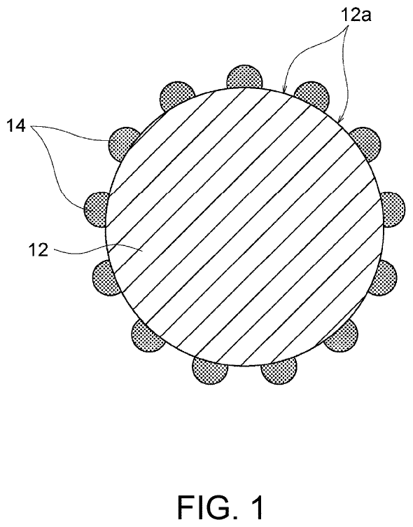

The negative electrode of the present invention is a negative electrode used in zinc secondary batteries. The negative electrode contains a negative electrode active material and a nonionic water-absorbing polymer. The negative electrode active material contains ZnO particles and Zn particles. FIG. 1 shows one aspect of the ZnO particle and nonionic water-absorbing polymer in the negative electrode of the present invention. As shown in FIG. 1, in the negative electrode according to the present invention, at least a portion of ZnO particles 12 is covered with a nonionic water-absorbing polymer 14. Thus, using as a negative electrode, a mixture containing nonionic water-absorbing polymer 14 together with the Zn particles and ZnO particles 12, wherein at least a portion of ZnO particle 12 is covered with nonionic water-absorbing polymer 14, makes it possible to prolong the cycle life.

As described above, in conventional negative electrodes, as zinc repeatedly dissolves and precipitates by repeated charge/discharge, the negative electrode changes its morphology, causing high resistance due to clogging of pores and a decrease in a charge active material due to accumulation of isolated zinc, which results in difficulty in charge and discharge. The matter of concern can be effectively inhibited or solved by adding to a negative electrode, a nonionic water-absorbing polymer so as to cover at least a portion of the ZnO particle. The mechanism is not necessarily clear; however, it is considered because adding the nonionic water-absorbing polymer homogenizes charging reaction and discharging reaction, respectively, which thereby inhibits zinc from being unevenly segregated or accumulated.

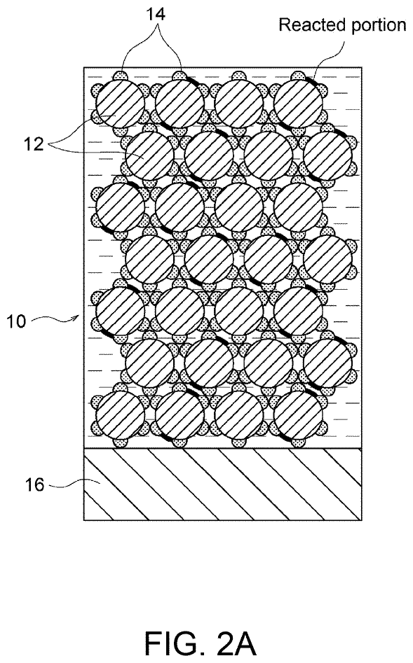

In other words, upon charging reaction, the reaction proceeds at the negative electrode based on ZnO+H₂O+2e⁻→Zn+2OH⁻. As the charging reaction proceeds, the OH⁻ concentration inside the negative electrode in the vicinity of a current collector becomes higher than the OH⁻ concentration on a surface of the negative electrode in the vicinity of a separator. As a result, the reaction inside the negative electrode slows down, whereas the above reaction on the surface of the negative electrode proceeds. Thus, in the conventional negative electrode, the charging reaction non-uniformly proceeds, from which zinc segregation is thought to result. As shown in FIG. 1, on the other hand, in negative electrode 10 of the present invention, at least a portion of ZnO particles 12 is covered with nonionic water-absorbing polymer 14. In this regard, since nonionic water-absorbing polymer 14 has no ion-permeability, a reactive portion 12a of ZnO particle 12 is limited to the portion not in contact with nonionic water-absorbing polymer 14. This limitation of reactive portion 12a of ZnO particle 12 is considered to render the charging reaction more uniform. Specifically, the charging reaction in negative electrode 10 of the present invention is presumed to proceed as follows. Here, the reactions of the negative electrode in an early stage, middle stage, and late stage, of charge are shown in FIGS. 2A to 2C, respectively. First, in the early stage of charge shown in FIG. 2A, the OH⁻ concentration in the periphery of negative electrode 10 is low, and therefore the reaction proceeds throughout negative electrode 10, regardless of its inside (the portion in the vicinity of current collector 16) or its surface (the portion far from current collector 16). Then, in the middle stage of charge shown in FIG. 2B, the OH⁻ concentration inside negative electrode 10 in the vicinity of current collector 16 increases, as described above, so that the reaction inside negative electrode 10 slows down, and the reaction on a surface of negative electrode 10 with an OH⁻ concentration low, proceeds preferentially. In the late stage of charge shown in FIG. 2C, on the other hand, ZnO particle 12 is covered with nonionic water-absorbing polymer 14, thereby reducing a reactive area on the surface of negative electrode 10. This allows the reaction to proceed inside negative electrode 10 again, thus rendering the charging reaction uniform. As a result, zinc is inhibited from its segregation, which is thought to make it possible to prolong the cycle life.

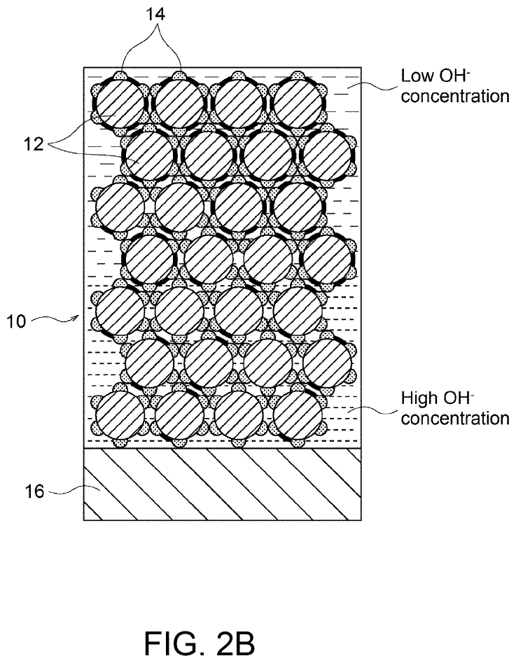

Moreover, upon discharging reaction, reaction in the negative electrode proceeds based on Zn+2OH⁻→ZnO+H₂O+2e⁻. As the discharging reaction progresses, the OH⁻ concentration inside the negative electrode in the vicinity of the current collector becomes lower than that on a surface of the negative electrode in the vicinity of the separator, which thereby slows down the reaction inside the negative electrode. Therefore, reaction in a conventional negative electrode is thought to become non-uniform, resulting in zinc accumulation. In negative electrode 10 of the present invention, on the contrary, nonionic water-absorbing polymer 14 conveniently absorbing water contributes to continuation of the reaction inside negative electrode 10. Here, FIGS. 3A and 3B each show a conceptual view of liquid absorption capacity of nonionic water-absorbing polymer 14 upon beginning and progress of the discharging reaction, respectively, in negative electrode 10 of the present invention. As shown in FIG. 3A, upon the beginning of the discharging reaction, since the OH⁻ concentration in an electrolytic solution 18 is high, the above discharging reaction proceeds regardless of a surface and the inside of negative electrode 10. As the discharging reaction proceeds, water is generated and the OH⁻ concentration in electrolytic solution 18 decreases (i.e., a pH decreases). In this regard, as shown in FIG. 3B, with decreasing the pH, nonionic water-absorbing polymer 14 increases its liquid absorption capacity, thereby assisting the above discharging reaction by absorbing water generated by the negative electrode active material. In other words, nonionic water-absorbing polymer 14 conveniently absorbing water for the discharging reaction in which water is generated, continues the discharging reaction inside negative electrode 10, rendering the discharging reaction uniform. It is though that zinc results in being inhibited from its accumulation, making it possible to prolong the cycle life. Incidentally, the advantageous effect of the present invention described above is a peculiar effect of the choice of nonionic water-absorbing polymer 14. In fact, addition of an ionic absorption polymer (for example, a polyacrylic acid or potassium polyacrylate) fails to enable the effects described above to be obtained, rather, reduces cycle characteristics.

Negative electrode active material contains Zn particles (not shown) and ZnO particles 12. The Zn particles are typically metallic Zn particles, however, Zn alloys or particles of a Zn compound may also be used. Metallic Zn particles that are commonly used in zinc secondary batteries can be used, however, smaller metal Zn particles are more preferably used from the standpoint of prolonging the cycle life of the battery. Specifically, the average particle diameter D50 of the metallic Zn particles is preferably 5 to 200 μm, more preferably 50 to 200 μm, and still more preferably 70 to 160 μm. The preferred content of Zn particles in negative electrode 10 is preferably 1.0 to 87.5 parts by weight, more preferably 3.0 to 70.0 parts by weight, and still more preferably 5.0 to 55.0 parts by weight, based on the content of ZnO particles 12 being 100 parts by weight. The metallic Zn particle may be doped with dopants such as In and Bi. The ZnO particles 12 are not particularly restricted provided that commercially available zinc oxide powder used for a zinc secondary battery or zinc oxide powder obtained by growing particles by a solid phase reaction, etc., by using these powders as starting materials, may be used. The average particle diameter D50 of the ZnO particles 12 is preferably 0.1 to 20 μm, more preferably 0.1 to 10 μm, and still more preferably 0.1 to 5 μm. Note, however, the average particle diameter D50 used herein shall refer to a particle diameter at which the integrated volume from the small particle diameter side reaches 50% in a particle size distribution obtained by a laser diffraction and scattering method. Preferably negative electrode 10 further contains one or more metallic elements selected from the group consisting of In and Bi. These metal elements can inhibit undesirable hydrogen gas from generating due to self-discharge of negative electrode 10. These metallic elements may be contained in negative electrode 10 in any form, such as metal, oxide, hydroxide, or other compounds, however, they are preferably contained in the form of oxide or hydroxide, more preferably in the form of oxide particles. The oxide of the metal element includes, for example, In₂O₃, Bi₂O₃, etc. The hydroxide of the metal element includes, for example, In(OH)₃, Bi(OH)₃, etc. In any case, preferably the content of In is 0 to 2 parts by weight in terms of oxide and the content of Bi is 0 to 6 parts by weight in terms of oxide, and more preferably the content of In is 0 to 1.5 parts by weight in terms of oxide and the content of Bi is 0 to 4.5 parts by weight in terms of oxide, based on the content of ZnO particles 12 being 100 parts by weight. When In and/or Bi are contained in negative electrode 10 in the form of oxide or hydroxide, not all of In and/or Bi need to be in the form of oxide or hydroxide, and they may be partially contained in the negative electrode in other forms such as metal or other compounds. For example, the above metal elements may be doped as trace elements in the metallic Zn particles. In this case, the concentration of In in the metallic Zn particles is preferably 50 to 2000 ppm by weight, more preferably 200 to 1500 ppm by weight, and the concentration of Bi in the metallic Zn particles is preferably 50 to 2000 ppm by weight and more preferably 100 to 1300 ppm by weight.

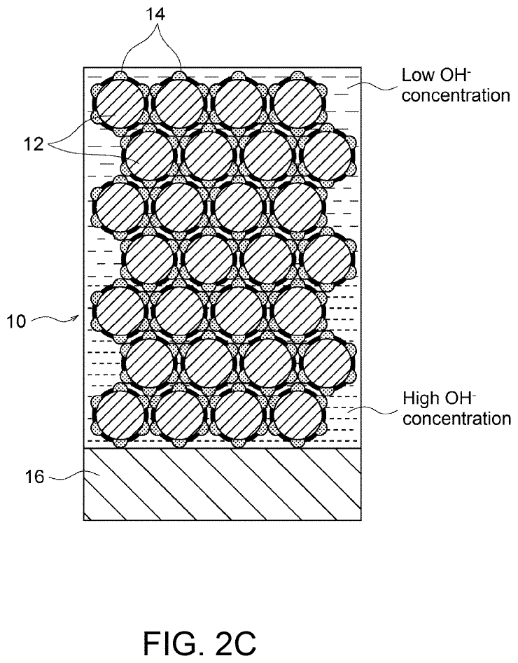

Nonionic water-absorbing polymer 14 can be any commercially available nonionic water-absorbing polymer, however, as described above, it is preferably a polymer having characteristics of change in liquid absorbency in response to variation of pH. FIG. 4 shows an example of the relationship between the amount of water absorbed and the amount of KOH collected per 1 cm³ of such a nonionic water-absorbing polymer, and the KOH concentration. As shown in FIG. 4, a nonionic water-absorbing polymer in which the amount of water absorbed changes with change in the KOH concentration in an electrolytic solution (i.e., change in the pH) but the amount of KOH collected does not change significantly, is preferred in terms of being capable of absorbing or releasing only water due to variation of pH. In particular, a nonionic water-absorbing polymer that demonstrates a behavior whereby the amount of water absorbed lowers with increasing pH is preferred. Preferred examples of such nonionic water-absorbing polymers 14 include a polyalkylene oxide-based water-absorbing resin, a polyvinylacetamide-based water-absorbing resin, polyvinyl alcohol (PVA resin), and polyvinyl butyral (PVB resin), and more preferred examples thereof include a polyalkylene oxide-based water-absorbing resin. The polyalkylene oxide-based water-absorbing resins that are commercially available can be used. The nonionic water-absorbing polymer 14 may contain at least one selected from the group consisting of a hydrophilic ether group, a hydroxyl group, an amide group, and an acetamide group. The presence of these functional groups allows for water absorption and desorption functions that are more desirable for battery reactions.

In negative electrode 10, nonionic water-absorbing polymer 14 covers at least a portion of ZnO particle 12. In other words, nonionic water-absorbing polymer 14 may be such that it covers a portion of a surface of ZnO particle 12, as shown in FIG. 1, or it covers the entire surface of ZnO particle 12. Moreover, nonionic water-absorbing polymer 14 may be such that it covers at least a portion of not only ZnO particle 12 but also the Zn particle. The coverage of ZnO particle 12 by nonionic water-absorbing polymer 14 is preferably 2 to 99%, more preferably 4 to 75%, still more preferably 16 to 75%, particularly preferably 49 to 75%, and most preferably 55 to 68%. The coverage of ZnO particle 12 in the present invention refers to a proportion (%) of the length of a portion where ZnO particle 12 and the nonionic water-absorbing polymer 14 are in contact with each other to the length of an outer circumferential part of ZnO particle 12 in an image analysis of a cross-section of negative electrode 10. The coverage of ZnO particle 12 can be preferably calculated according to the procedure described in Evaluation 2 of Example 2 below.

A method for covering ZnO particle 12 with nonionic water-absorbing polymer 14 is not particularly limited. For example, the methods (a) to (d) described below can favorably cover ZnO particle 12 with nonionic water-absorbing polymer 14.

(a) Mixed powder containing Zn particles, ZnO particles 12, nonionic water-absorbing polymer 14, and a binder (for example, polytetrafluoroethylene) is prepared. This mixed powder is heated and kneaded together with a solvent (for example, propylene glycol, isopropyl alcohol) at a predetermined temperature (for example, at a temperature of the melting point or higher of nonionic water-absorbing polymer 14).
(b) Nonionic water-absorbing polymer 14 is dissolved in a solvent at a predetermined temperature. The solvent in which nonionic water-absorbing polymer 14 was dissolved was added to the ZnO particles and Zn particles, and the mixture is mixed by a pot mill or the like, and then dried to form polymer-covered powder. Thereafter, the resulting polymer-covered powder and a binder resin are kneaded together with the solvent.
(c) To mixed powder containing the Zn particles, ZnO particles 12, and the binder resin is added nonionic water-absorbing polymer 14 in a state of being dissolved in a solvent, and then the mixture is kneaded.
(d) The resulting negative electrode 10 is sealed and heated at a temperature of the melting point or higher of nonionic water-absorbing polymer 14.

The melting point of the nonionic water-absorbing polymer is preferably 45° C. to 350° C., more preferably 45° C. to 200° C., and still more preferably 50° C. to 100° C. Moreover, the content of nonionic water-absorbing polymer 14 in negative electrode 10 is preferably 0.01 to 6.0 parts by weight on a solid basis, more preferably 0.01 to 5.0 parts by weight, still more preferably 0.5 to 4.5 parts by weight, and particularly preferably 1.5 to 4.5 parts by weight, based on the content of ZnO particles 12 being 100 parts by weight.

Negative electrode 10 may further contain a conductive aid. Examples of the conductive aid include carbon, metal powders (tin, lead, copper, cobalt, and the like), and noble metal pastes.

Negative electrode 10 may further contain a binder resin (not shown). The negative electrode 10 comprising the binder maintains the shape of the negative electrode more easily. Various known binders can be used as the binder resin and a preferable example thereof is polyvinyl alcohol (PVA) and polytetrafluoroethylene (PTFE). Both PVA and PTFE are particularly preferably combined for use as the binder.

The negative electrode 10 is preferably a sheet-like pressed product, and thereby it is possible to prevent the negative electrode active material from falling off and improve the electrode density, which more effectively inhibits the morphological change of the negative electrode 10. Such a sheet-like pressed product can be fabricated by adding a binder to a negative electrode material followed by kneading, and pressing the obtained kneaded product by a roll press machine, etc., into a sheet. The preferred kneading method for covering ZnO particle 12 with nonionic water-absorbing polymer 14 is as described above.

A current collector 16 is preferably provided on the negative electrode 10. The current collector 16 preferably includes, for example, a copper punching metal and a copper expanded metal. In this case, for example, a negative electrode plate composed of negative electrode 10/current collector 16 can be favorably fabricated by coating a surface of a copper punching metal or a copper expanded metal with a mixture containing Zn particles, ZnO particles 12, a nonionic water-absorbing polymer 14, and a binder resin (for example, polytetrafluoroethylene particles), if necessary. At this time, the negative electrode plate (i.e., the negative electrode 10/the current collector 16) after drying is also preferably subjected to press treatment to prevent the negative electrode active material from falling off and improve the electrode density. Alternatively, the sheet-like pressed product as described above may be compressed and bonded to a current collector 16 such as a copper expanded metal.

### Zinc Secondary Battery

The negative electrode 10 of the present invention is preferably applied to a zinc secondary battery. Therefore, according to a preferred embodiment of the present invention, a zinc secondary battery comprising a positive electrode (not shown), a negative electrode 10, a separator separating the positive electrode from the negative electrode 10 so as to be capable of conducting hydroxide ions therethrough, and an electrolytic solution 18, is provided. The zinc secondary battery of the present invention is not particularly limited provided that it is a secondary battery in which negative electrode 10 described above is used and an electrolytic solution 18 (typically an aqueous alkali metal hydroxide solution) is used. Therefore, it can be a nickel-zinc secondary battery, a silver oxide-zinc secondary battery, a manganese oxide-zinc secondary battery, a zinc-air secondary battery, or various other alkaline-zinc secondary batteries. For example, a positive electrode preferably comprises nickel hydroxide and/or nickel oxyhydroxide whereby the zinc secondary battery forms a nickel-zinc secondary battery. Alternatively, the positive electrode may be an air electrode whereby the zinc secondary battery forms a zinc-air secondary battery.

The separator is preferably a layered double hydroxide (LDH) separator. As described above, LDH separators have been known in the field of nickel-zinc secondary batteries or zinc-air secondary batteries (see Patent Literatures 1 to 3), and an LDH separator can also be preferably used for the zinc secondary battery of the present invention. The LDH separator can prevent the penetration of zinc dendrites while selectively allowing hydroxide ions to permeate. Combined with the effect of adopting the negative electrode of the present invention, the durability of the zinc secondary battery can be further improved. Incidentally, the LDH separator herein is defined as a separator including a layered double hydroxide (LDH) and/or an LDH-like compound (hereinafter collectively referred to as a hydroxide ion-conducting layered compound), which selectively passes hydroxide ions by exclusively utilizing hydroxide ion conductivity of the hydroxide ion-conducting layered compound. The “LDH-like compound” herein, although it may not be called an LDH, is hydroxide and/or oxide with a layered crystal structure analogous to LDH, and can be considered as an equivalent of LDH. In a broader definition, however, “LDH” can also be interpreted to include not only LDH but also the LDH-like compound.

The LDH separator may be composited with porous substrates as disclosed in Patent Literatures 1 to 3. The porous substrate may be composed of any of ceramic materials, metallic materials, and polymer materials; however, it is particularly preferably composed of the polymer materials. The polymer porous substrate has advantages of 1) flexibility (hence, it is hard to break even if being thin.), 2) facilitation of increase in porosity, 3) facilitation of an increase in conductivity (because it can be rendered thin while increasing porosity.), and 4) facilitation of manufacture and handling. The polymer material is particularly preferably polyolefins such as polypropylene, polyethylene, etc., and most preferably polypropylene, in terms of excellent hot-water resistance, excellent acid resistance and excellent alkali resistance as well as low cost. When the porous substrate is composed of the polymer material, a hydroxide ion-conducting layered compound is particularly preferably incorporated over the entire region of the thickness direction of the porous substrate (for example, most or almost all the pores inside the porous substrate are filled with the hydroxide ion-conducting layered compound.). In this case, the thickness of the polymer porous substrate is preferably 5 to 200 μm, more preferably 5 to 100 μm, and still more preferably 5 to 30 μm. A microporous membrane that is commercially available as a separator for lithium batteries can be preferably used as such polymer porous substrates.

The electrolytic solution 18 preferably comprises an alkali metal hydroxide aqueous solution. The alkali metal hydroxide includes, for example, potassium hydroxide, sodium hydroxide, lithium hydroxide, ammonium hydroxide, etc., however, potassium hydroxide is more preferred. Zinc oxide, zinc hydroxide, etc., may be added to the electrolytic solution in order to inhibit spontaneous dissolution of the zinc-containing material.

### LDH-Like Compound

According to a preferred aspect of the present invention, the LDH separator can be such that it contains an LDH-like compound; the definition of the LDH-like compound is as described above. A preferred LDH-like compound is as follows:

(a) Hydroxide and/or oxide with a layered crystal structure containing Mg and one or more elements with at least Ti, selected from the group consisting of Ti, Y, and Al; or
(b) hydroxide and/or oxide with a layered crystal structure containing (i) Ti, Y, and optionally Al and/or Mg and (ii) an additive element M that is at least one type selected from the group consisting of In, Bi, Ca, Sr and Ba; or
(c) hydroxide and/or oxide with a layered crystal structure containing Mg, Ti, Y, and optionally Al and/or In, wherein the LDH-like compound is present in the form of a mixture with In(OH)₃ in (c).

According to the preferred aspect (a) of the present invention, the LDH-like compound can be hydroxide and/or oxide with a layered crystal structure containing Mg and one or more elements with at least Ti, selected from the group consisting of Ti, Y, and Al. Thus, a typical LDH-like compound is complex hydroxide and/or complex oxide of Mg, Ti, optionally Y, and optionally Al. The aforementioned elements may be replaced by other elements or ions to the extent that the basic characteristics of the LDH-like compound are not impaired; however, the LDH-like compound is preferably free of Ni. For example, the LDH-like compound may be such that it further contains Zn and/or K. This can further improve the ionic conductivity of the LDH separator.

The LDH-like compound can be identified by X-ray diffraction. Specifically, when an LDH separator undergoes X-ray diffraction on its surface, a peak derived from the LDH-like compound is typically detected in the range of 5°≤2θ≤10° and more typically in the range of 7°≤2θ≤10°. As described above, LDH is a substance with an alternating stacked structure in which exchangeable anions and H₂O are present as an intermediate layer between the stacked hydroxide base layers. In this regard, when an LDH is measured by an X-ray diffraction method, a peak (i.e., the (003) peak of LDH) is essentially detected at the position of 2θ=11 to 12° derived from a crystal structure of LDH. When the LDH-like compound is measured by the X-ray diffraction method, on the contrary, a peak is typically detected in the range described above that is shifted to the lower angle side than the position of the aforementioned peak of LDH. Moreover, using the 2θ corresponding to the peak derived from the LDH-like compound in the X-ray diffraction enables determination of the interlayer distance of the layered crystal structure according to the Bragg formula. The interlayer distance of the layered crystal structure constituting the LDH-like compound determined in such a way is typically 0.883 to 1.8 nm and more typically 0.883 to 1.3 nm.

The LDH separator according to the aspect (a) above has an atomic ratio of Mg/(Mg+Ti+Y+Al) in the LDH-like compound of preferably 0.03 to 0.25 and more preferably 0.05 to 0.2, as determined by energy dispersive X-ray spectroscopy (EDS). Further, the atomic ratio of Ti/(Mg+Ti+Y+Al) in the LDH-like compound is preferably 0.40 to 0.97 and more preferably 0.47 to 0.94. Furthermore, the atomic ratio of Y/(Mg+Ti+Y+Al) in the LDH-like compound is preferably 0 to 0.45 and more preferably 0 to 0.37. In addition, the atomic ratio of Al/(Mg+Ti+Y+Al) in the LDH-like compound is preferably 0 to 0.05 and more preferably 0 to 0.03. The ratios within the above ranges render alkali resistance more excellent and make it possible to more effectively achieve an inhibition effect of short circuits caused by zinc dendrites (i.e., dendrite resistance). By the way, an LDH, which has been conventionally known for an LDH separator, can be represented by the basic composition with the general formula: M²⁺₁₋ₓM³⁺ₓ(OH)₂Aⁿ⁻_{x/n}-mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to another preferred aspect (b) of the present invention, the LDH-like compound can be hydroxide and/or oxide with a layered crystal structure containing (i) Ti, Y, and optionally Al and/or Mg, and (ii) additive element M. Thus, a typical LDH-like compound is complex hydroxide and/or complex oxide of Ti, Y, additive element M, optionally Al, and optionally Mg. Additive element M is In, Bi, Ca, Sr, Ba or combinations thereof. The above elements may be replaced by other elements or ions to the extent that the basic characteristics of the LDH-like compound are not impaired; however, the LDH-like compound is preferably free of Ni.

The LDH separator according to the aspect (b) above preferably has an atomic ratio of Ti/(Mg+Al+Ti+Y+M) in the LDH-like compound of 0.50 to 0.85 and more preferably 0.56 to 0.81, as determined by energy dispersive X-ray spectroscopy (EDS). The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to 0.10 and more preferably 0 to 0.02. In addition, the atomic ratio of Al/(Mg+Al+Ti+Y+M) in the LDH-like compound is preferably 0 to 0.05 and more preferably 0 to 0.04. The ratios within the above ranges render the alkali resistance more excellent and make it possible to more effectively achieve an inhibition effect of short circuits caused by zinc dendrites (i.e., dendrite resistance). By the way, an LDH, which has been conventionally known regarding a LDH separator, can be represented by a basic composition with the general formula: M²⁺₁₋ₓM³⁺ₓ(OH)₂Aⁿ⁻_{x/n}-mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of the conventional LDH. Incidentally, EDS analysis is preferably carried out with an EDS analyzer (for example, an X-act manufactured by Oxford Instruments) by 1) capturing an image at an accelerating voltage of 20 kV and a magnification of 5,000 times, 2) carrying out a three-point analysis at approximately 5 μm intervals in a point analysis mode, 3) repeating the above 1) and 2) once more, and 4) calculating an average value of a total of 6 points.

According to yet another preferred aspect (c) of the present invention, the LDH-like compound can be hydroxide and/or oxide with a layered crystal structure containing Mg, Ti, Y, and optionally Al and/or In, wherein the LDH-like compound is present in the form of a mixture with In(OH)₃. The LDH-like compound of this aspect is hydroxide and/or oxide with a layered crystal structure containing Mg, Ti, Y, and optionally Al and/or In. Thus, a typical LDH-like compound is complex hydroxide and/or complex oxide of Mg, Ti, Y, optionally Al, and optionally In. It is to be noted that In that can be contained in the LDH-like compound may be not only In that is intended to be added to the LDH-like compound, but also In that is unavoidably incorporated into the LDH-like compound derived from the formation of In(OH)₃, or the like. The above elements can be replaced by other elements or ions to the extent that the basic characteristics of the LDH-like compound are not impaired; however, the LDH-like compound is preferably free of Ni. By the way, an LDH, which has been conventionally known regarding a LDH separator, can be represented by a basic composition with the general formula: M²⁺₁₋ₓM³⁺ₓ(OH)₂Aⁿ⁻_{x/n}-mH₂O wherein in the formula, M²⁺ is a divalent cation, M³⁺ is a trivalent cation, and Aⁿ⁻ is an n-valent anion, n is an integer of 1 or more, x is 0.1 to 0.4, and m is 0 or more. The above atomic ratios in the LDH-like compound, on the contrary, generally deviate from those of the above general formula of LDH. Therefore, it can be deemed that the LDH-like compound in the present aspect generally has a composition ratio (atomic ratio) that is different from that of a conventional LDH.

The mixture according to the aforementioned aspect (c) contains not only the LDH-like compound but also In(OH)₃ (typically composed of the LDH-like compound and In(OH)₃). Containing In(OH)₃ in the mixture enables effective improvement in the alkali resistance and dendrite resistance of an LDH separator. The content proportion of In(OH)₃ in the mixture is preferably an amount that can improve the alkali resistance and dendrite resistance without impairing hydroxide ion conductivity of an LDH separator, and is not particularly limited. In(OH)₃ may be such that it has a cubic crystalline structure and also has a configuration in which the crystalline of In(OH)₃ is surrounded by the LDH-like compound. The In(OH)₃ can be identified by X-ray diffraction.

### EXAMPLES

The present invention will be described in more detail with reference to the following Examples.

### Examples 1 to 12

### (1) Preparation of Positive Electrode

A paste-type nickel hydroxide positive electrode (capacity density: about 700 mAh/cm³) was prepared.

### (2) Fabrication of Negative Electrode

Various raw material powders shown below were prepared.
ZnO powder (manufactured by Seido Chemical Industry Co., Ltd., JIS Standard Class 1 grade, average particle size D50: 0.2 μm)
Metallic Zn powder (doped with Bi and In, Bi: 70 ppm by weight, In: 200 ppm by weight, average particle diameter D50: 120 μm, manufactured by Dowa Electronics Materials Co., Ltd.)
Nonionic water-absorbing polymer (polyalkylene oxide-based water-absorbing resin, Aqua Calk, grade: TWB-P, product form: powder, average particle diameter D50: 50 μm, manufactured by Sumitomo Seika Chemicals Co., Ltd.)
Ionic water-absorbing polymer (polyacrylic acid, AQUPEC HV, manufactured by Sumitomo Seika Chemicals Co., Ltd.)
Ionic water-absorbing polymer (potassium polyacrylate, Poly partial potassium salt, manufactured by Sigma-Aldrich Co. LLC)

To 100 parts by weight of ZnO powder were added 5.7 parts by weight of metallic Zn powder, 1 part by weight of polytetrafluoroethylene (PTFE), as well as a nonionic water-absorbing polymer or an ionic water-absorbing polymer, if necessary, in each proportion compounded listed in Tables 1 and 2, and the mixture was heated and kneaded with propylene glycol. In such a way, the mixture was kneaded while dissolving the nonionic water-absorbing polymer or the ionic water-absorbing polymer in the propylene glycol. The obtained kneaded product was rolled by a roll press to obtain a negative electrode active material sheet. The negative electrode active material sheet was compressed and adhered to a tin-plated copper expanded metal to obtain a negative electrode.

### (3) Preparation of Electrolytic Solution

Ion-exchanged water was added to a 48% potassium hydroxide aqueous solution (manufactured by Kanto Chemical Co., Inc., special grade) to adjust the KOH concentration to 5.4 mol %, and then zinc oxide was dissolved at 0.42 mol/L by heating and stirring to obtain an electrolytic solution.

### (4) Fabrication of Evaluation Cell

The positive electrode and the negative electrode were each wrapped with a nonwoven fabric, and each welded with a current extraction terminal. The positive electrode and the negative electrode thus fabricated were opposed to each other with the LDH separator interposed therebetween, sandwiched by a laminated film provided with a current extraction port, and the laminated film was heat-sealed on three sides thereof. The electrolytic solution was added to the obtained cell container with the upper side being opened, and was sufficiently permeated into the positive electrode and the negative electrode by vacuum evacuation, etc. Thereafter the remaining one side of the laminated film was also heat-sealed to form a simply sealed cell.

### (5) Evaluation

### Evaluation 1: Present State of Nonionic Water-Absorbing Polymer

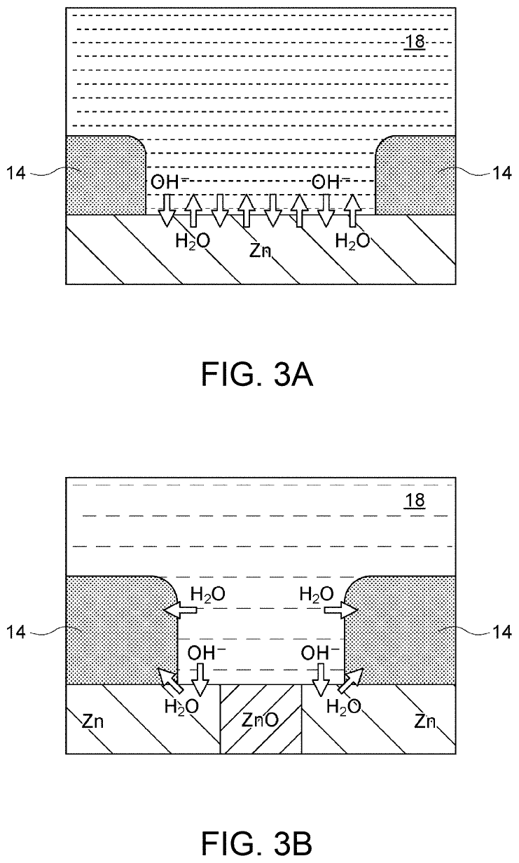

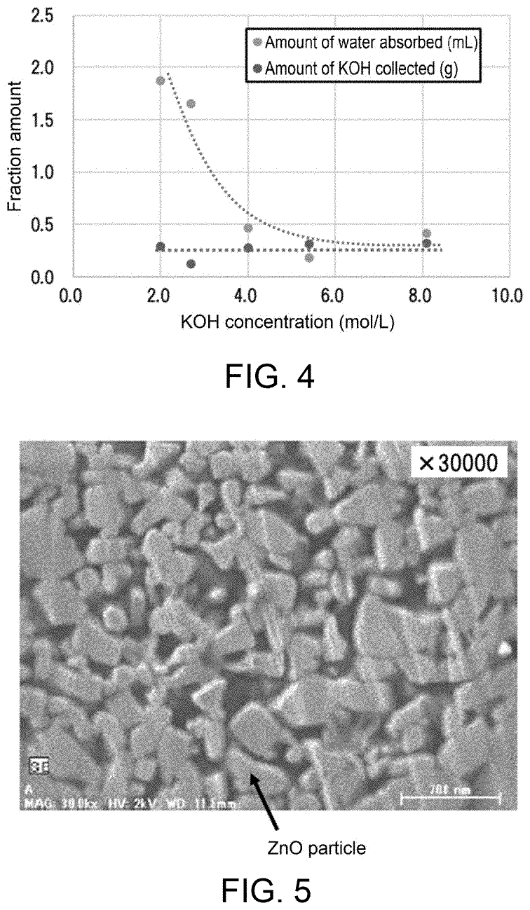

The negative electrodes of Examples 1 to 8 underwent cross-sectional polishing by a cross-section polisher (CP), and each negative electrode cross-section underwent FE-SEM observation and EDX observation using a field emission scanning electron microscope (FE-SEM, S-4800, manufactured by Hitachi High-Tech Corporation) equipped with an energy dispersive X-ray spectroscope (EDX) at a magnification of 30,000 times. The FE-SEM image and EDX elemental mapping image obtained in Example 5 are shown in FIGS. 5 and 6, respectively. As shown in FIG. 6, the EDX elemental mapping image confirmed the presence of C and F in the negative electrode. In this regard, the negative electrodes of Examples 1 to 8 each contain the nonionic water-absorbing polymer and PTFE as resins; however, since the PTFE contains F, the area where only C was detected is thought to be an area derived from the nonionic water-absorbing polymer, as a result of which the nonionic water-absorbing polymer was confirmed to be present in the form of covering at least a portion of the ZnO particle.

### Evaluation 2: Calculation of Coverage

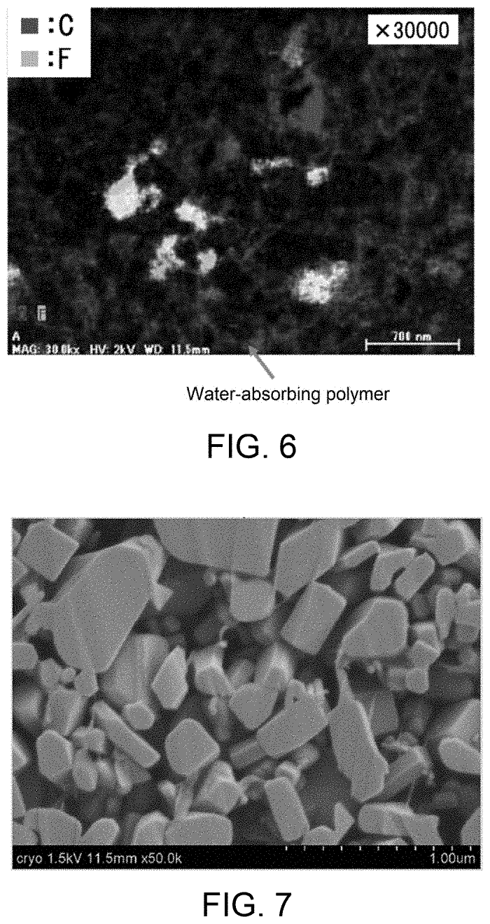

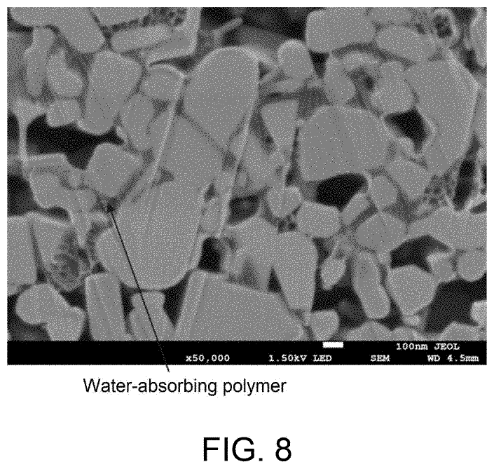

The negative electrodes of Examples 1 to 8 each underwent negative electrode cross-section observation using a field emission scanning electron microscope (FE-SEM, JSM-7900M, manufactured by JEOL Ltd.) at a magnification of 50,000 times (field of view: 2.3 μm×1.6 μmm). The FE-SEM images of the negative electrode cross-sections obtained in Example 1 (Comparative Example) and Example 6 are shown in FIGS. 7 and 8, respectively. The FE-SEM images acquired were imported into an image processing software (Adobe Illustrator, manufactured by Adobe, Inc.). Next, length L₁ of a portion where a ZnO particle and a nonionic water-absorbing polymer are in contact with each other in an outer circumferential part of the ZnO particle included in the field of view, and length L₂ where the ZnO particle and a void (location where the nonionic water-absorbing polymer is absent) are in contact with each other, were measured. Then, a proportion (%) of the length of the portion where the ZnO particle and the nonionic water-absorbing polymer are in contact with each other to the length of the outer circumferential part of the ZnO particle is determined according to the following formula:

[L₁/(L₁+L₂)]×100

and the obtained proportion is defined as a coverage of Zn particle. The results are shown in Table 1.

### Evaluation 3: Cycle Characteristics

Chemical conversion was carried out on the simply sealed cell with 0.1C charge and 0.2C discharge by using a charge/discharge apparatus (TOSCAT3100 manufactured by Toyo System Co., Ltd.). Then, a 1C charge/discharge cycle was carried out. Repeated charge/discharge cycles were carried out under the same conditions, and the number of charge/discharge cycles until a discharging capacity decreased to 70% of the discharging capacity of the first cycle of the prototype battery was recorded, the procedure of which was adopted as an indicator of cycle characteristics. The results are as shown in Table 1, and confirmed that the negative electrode to which a specified amount of the nonionic water-absorbing polymer was added, improved the cycle characteristics by covering the ZnO particle with the nonionic water-absorbing polymer. The results shown in Table 2 also confirmed that the addition of the ionic water-absorbing polymer rather lowers the cycle characteristics.

TABLE 1

| | Negative electrode | Evaluation | |
|---|---|---|---|
| | Amount of nonionic water- | Coverage of ZnO | |
| | absorbing polymer added | particle by nonionic | |
| | relative to 100 parts by weight of | water-absorbing | |
| | ZnO particles | polymer | |
| | (parts by weight) | (%) | Cycle characteristics |
| Example 1* | 0 | 0 | 550 |
| Example 2 | 0.01 | 2 | 600 |
| Example 3 | 0.1 | 4 | 790 |
| Example 4 | 0.5 | 16 | 860 |
| Example 5 | 1 | 37 | 840 |
| Example 6 | 3 | 61 | 1100 |
| Example 7 | 4.5 | 75 | 900 |
| Example 8 | 6 | 99 | 580 |

*denotes Comparative Example.

TABLE 2

| | Negative electrode | | |
|---|---|---|---|
| | | Amount of ionic water-absorbing polymer | |
| | | added relative to 100 parts by weight of | Evaluation |
| | | ZnO particles | Cycle |
| | Polymer type | (parts by weight) | characteristics |
| Example 9* | — | 0 | 550 |
| Example 10* | Polyacrylic acid | 1 | 400 |
| Example 11* | Potassium | 1 | 400 |
| | polyacrylate | | |
| Example 12* | Potassium | 3 | 350 |
| | polyacrylate | | |

*denotes Comparative Example.

What is claimed is:

1. A negative electrode for use in a zinc secondary battery, comprising:
a negative electrode active material comprising ZnO particles and Zn particles, and
a nonionic water-absorbing polymer,
wherein at least a portion of the ZnO particles is covered with the nonionic water-absorbing polymer.

2. The negative electrode according to claim 1, wherein a coverage of the ZnO particles is 2 to 99%, and the coverage is a proportion of the length of a portion where the ZnO particle and the nonionic water-absorbing polymer are in contact with each other to the length of an outer circumferential part of the ZnO particle in an image analysis of a cross-section of the negative electrode.

3. The negative electrode according to claim 1, wherein the coverage of the ZnO particles is 4 to 75%.

4. The negative electrode according to claim 1, comprising the nonionic water-absorbing polymer in an amount of 0.01 to 6.0 parts by weight on a solid basis, based on the content of the ZnO particles being 100 parts by weight.

5. The negative electrode according to claim 1, wherein the nonionic water-absorbing polymer is at least one selected from the group consisting of a polyalkylene oxide-based water-absorbing resin, a polyvinylacetamide-based water-absorbing resin, polyvinyl alcohol (PVA resin), and polyvinyl butyral (PVB resin).

6. The negative electrode according to claim 1, wherein the nonionic water-absorbing polymer is a polyalkylene oxide-based water-absorbing resin.

7. The negative electrode of claim 1, wherein the nonionic water-absorbing polymer has characteristics of change in liquid absorbency in response to variation of pH.

8. The negative electrode according to claim 1, comprising the Zn particles in an amount of 1.0 to 87.5 parts by weight, based on the content of the ZnO particles being 100 parts by weight.

9. The negative electrode according to claim 1, further comprising one or more metal elements selected from the group consisting of In and Bi.

10. The negative electrode according to claim 1, wherein the negative electrode is a sheet-like pressed product.

11. A zinc secondary battery, comprising:
a positive electrode,
the negative electrode according to claim 1,
a separator separating the positive electrode from the negative electrode so as to be capable of conducting hydroxide ions therethrough, and
an electrolytic solution.

12. The zinc secondary battery according to claim 11, wherein the separator is an LDH separator comprising a layered double hydroxide (LDH) and/or an LDH-like compound.

13. The zinc secondary battery according to claim 11, wherein the LDH separator is composited with a porous substrate.

14. The zinc secondary battery according to claim 11, wherein the positive electrode comprises nickel hydroxide and/or nickel oxyhydroxide whereby the zinc secondary battery forms a nickel-zinc secondary battery.

15. The zinc secondary battery according to claim 11, wherein the positive electrode is an air electrode whereby the zinc secondary battery forms a zinc-air secondary battery.
